(19) United States
(12) Patent Application Publication
(10) Pub. No.: US 2026/0203810 A1
(43) Pub. Date: Jul. 16, 2026

(54) COMPUTER-IMPLEMENTED METHODS, SYSTEMS COMPRISING COMPUTER-READABLE MEDIA, AND ELECTRONIC DEVICES FOR PROVIDING DYNAMIC OPEN BANKING DATA AGGREGATION

(71) Applicant: Mastercard International Incorporated, Purchase, NY (US)

(72) Inventors: Justin Harnish, Salt Lake City, UT (US); Amy Schimandle, Holladay, UT (US); Anil Kakarla Iyer, Sunnyvale, CA (US); Daman Bareiss, Salt Lake City, UT (US); Mahima Caprihan, Ry Brook, NY (US); Natesh Babu Arunachalam, Herriman, UT (US)

(73) Assignee: Mastercard International Incorporated, Purchase, NY (US)

(21) Appl. No.: 19/020,795

(22) Filed: Jan. 14, 2025

(51) Int. Cl. G06Q 40/02; G06N 3/12

(52) U.S. Cl. CPC G06Q 40/02; G06N 3/12

(57) ABSTRACT

A computer-implemented method for providing dynamic open banking data aggregation that includes: applying pre-model rules to data regarding financial institution (FI) accounts to determine that a first subset of the FI accounts will be included in an aggregation batch; inputting the data regarding a second subset of the FI accounts to a machine learning (ML) model to determine that a third subset of the FI accounts will be included in the aggregation batch and that a fourth subset of the FI accounts will not be included in the aggregation batch; based on the determination from the application of the pre-model rules and on the determination from the ML model, respectively, requesting data updates for the first and third subsets from the FI; batching the aggregation batch by processing the data updates for the first and third subsets to produce results; and storing the results to an aggregated data store.

### FIELD OF THE INVENTION

The present disclosure generally relates to computer-implemented methods, systems comprising computer-readable media, and electronic devices for providing dynamic open banking data aggregation and, more particularly, to dynamic management of skip batch decisioning by a machine learning model.

### BACKGROUND

Open banking services provide secure platforms for the aggregation, exchange and validation of financial information. The platforms often enable greater visibility for lenders into potential borrowers'financial lives to support better decisioning. They also help banks and other financial institutions interact with consumers and one another, as well provide services to and consented data sharing with entities such as credit reporting bureaus and the like.

Serving as an information intermediary between so many diverse entities gives rise to technological challenges, requiring onerous manual intervention and decision-making. For example, efficient aggregation of data balanced against timeliness requirements, as well as the inherent structure (or lack thereof) of open banking data, present barriers to efficient operation and timely service. Further, automating technological interventions and decision-making is difficult or impossible to achieve in a dynamic manner with existing technologies.

This background discussion is intended to provide information related to the present invention which is not necessarily prior art.

### BRIEF SUMMARY

Embodiments of the present technology relate to computer-implemented methods, systems comprising computer-readable media, and electronic devices for providing dynamic open banking data aggregation. The embodiments provide a technological mechanism for automatically and dynamically adapting batching and data aggregation operations and decisioning for improved and efficient provision of open banking services.

More particularly, in an aspect, a computer-implemented method for providing dynamic open banking data aggregation may be provided. The method may include: applying pre-model rules to data regarding financial institution (FI) accounts to determine that a first subset of the FI accounts will be included in an aggregation batch; inputting the data regarding a second subset of the FI accounts to a machine learning (ML) model to determine that a third subset of the FI accounts will be included in the aggregation batch and that a fourth subset of the FI accounts will not be included in the aggregation batch; based on the determination from the application of the pre-model rules and on the determination from the ML model, respectively, requesting data updates for the first and third subsets from the FI; batching the aggregation batch by processing the data updates for the first and third subsets to produce results; and storing the results to an aggregated data store. The method may include additional, less, or alternate actions, including those discussed elsewhere herein.

In another aspect, non-transitory computer-readable storage media having computer-executable instructions stored thereon for providing dynamic open banking data aggregation may be provided. When executed by at least one processor the computer-executable instructions cause the at least one processor to: apply pre-model rules to data regarding financial institution (FI) accounts to determine that a first subset of the FI accounts will be included in an aggregation batch; input the data regarding a second subset of the FI accounts to a machine learning (ML) model to determine that a third subset of the FI accounts will be included in the aggregation batch and that a fourth subset of the FI accounts will not be included in the aggregation batch; based on the determination from the application of the pre-model rules and on the determination from the ML model, respectively, request data updates for the first and third subsets from the FI; batch the aggregation batch by processing the data updates for the first and third subsets to produce results; and store the results to an aggregated data store. The instructions, when executed, may cause the at least one processor to perform additional, less, or alternate actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for providing dynamic open banking data aggregation in accordance with embodiments of the present invention;

FIGS. 2, 3 and 4 illustrate various components of exemplary computing devices shown in block schematic form that may be used with the system of FIG. 1;

FIG. 5 is a flowchart of exemplary systems and components thereof for providing dynamic open banking data aggregation, in accordance with embodiments of the present invention; and

FIG. 6 illustrates at least a portion of the steps of an exemplary computer-implemented method for providing dynamic open banking data aggregation in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods for providing open banking services are heavily manual and often incorporate a patchwork of disparate technological tools. Further, adjusting such methods to account for multivariate aspects of providing open banking services requires extensive and time-consuming manual efforts.

A more efficient, dynamic method for dynamic open banking data aggregation is needed.

According to embodiments of the present invention, a technological mechanism is provided for improved open banking services via a machine learning model. Namely, embodiments of the present invention automatically take steps to manage financial institution (FI) data pulls subject to rate limits while, in parallel, automatically evolving to optimize cost-effective provision of open banking services in a multivariate problem space.

### Exemplary System

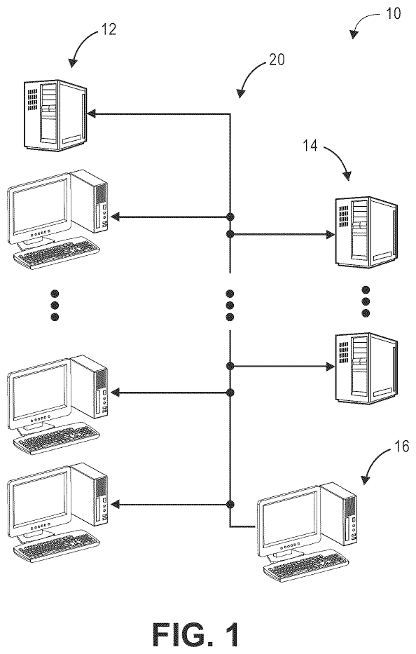

FIG. 1 depicts an exemplary environment 10 for providing dynamic open banking data aggregation according to embodiments of the present invention. The environment may include a plurality of client devices 12, a plurality of servers 14, a service device 16, and a communication network 20. Client devices 12, servers 14 and the service device 16 may be located within network boundaries of an organization, such as a corporation or the like that provides open banking services. One or more client devices 12 and servers 14 may also be outside the network boundaries of the organization.

The communication network 20 may be partly or even mostly internal to the organization, for example where the servers 14 manage databases of and/or provide cloud-based services to and under the management of the organization, and a client device 12 is also under the management of the organization. Also or alternatively, the client devices 12, servers 14 and service device 16 may access each other via transmissions, at least in part, across public/semi-public telecommunication network infrastructure, with the communication network 20 being at least in part comprised of such public/semi-public telecommunication network infrastructure.

All or some of the client devices 12, servers 14, service device 16 and/or all or some of the virtual resources managed thereby, may at least partly comprise a secure network computing environment. Alternatively or in addition, the service device 16 may manage access and transmissions between and among itself and the client devices 12 and servers 14 under an authentication management framework. For example, each user of a client device 12 may be required to complete an authentication process to access secure data provided via the servers 14 and/or the services provided by service device 16. In one or more embodiments, any authentication management framework may be utilized including, without limitation, custom frameworks.

For example, the service device 16 may host, aggregate and analyze data and host and provide access to/use of applications comprising open banking services. In one or more embodiments, the open banking services comprise data aggregation, analysis, management and data sharing services whereby consumers and businesses may subscribe for consented and controlled sharing of data with financial service providers and/or institutions.

Data subjects (e.g., consumers and businesses seeking financial services from financial service providers) may subscribe for the open banking services, and identify one or more financial accounts or data/documents sources from which to share data and/or directly provide copies of financial and identification information (e.g., access credentials) and documents. The data subjects may also consent to controlled sharing of such financial, identity-and/or location-related information with the open banking services of the service device 16 and, in turn, with consented data recipients (e.g., the financial service providers).

In turn, data recipients (e.g., lenders, credit score agencies, credit card service providers, or other financial institutions or financial service providers) may subscribe and access the open banking services and subject data, for example to calculate credit scores, open new financial accounts, provide advice about improving credit scores, approve loan requests from data subjects, and perform other financial services.

The consented data provided with the permission of data subjects may be provided directly (e.g., via upload from client devices 12) and/or by directive of the data subjects given to the service device 16 and/or one or more servers 14. For example, a data subject may provide access credentials used to access server(s) 14 which host financial institution (FI) or service provider application programming interfaces (APIs), with such APIs providing access to the data subject's financial account records. The data subject may thereby direct the server 14, whether directly or indirectly, to provide the service device 16 with all or some such financial account records, and may establish conditions and parameters around such sharing and/or around subsequent sharing by the service device 16 with data recipients (e.g., financial service providers also subscribed to the open banking services). Consenting to and retrieval of data subject data may take a variety of forms and utilize a variety of data sources having a variety of formats, within the scope of the present invention.

Accordingly, data subjects and data recipients may subscribe for the open banking services, for example through the use of and access provided by service device 16. The open banking services may be provided by the service device 16 to the client devices 12 and/or servers 14. The open banking service provider may also or alternatively include servers 14, for example where the service provider has consented access to credit card transaction records and data of the data subjects and/or which may be accessed to enhance analyses and data enrichment services performed by the open banking service provider.

One of ordinary skill will appreciate that embodiments may serve a wide variety of individuals and organizations and/or rely on a wide variety of data sources (and formats) and/or service providers within the scope of the present invention. It should also be noted that reference herein to a “business organization,” “corporation” or the like are made for ease of reference, and that embodiments of the present invention are equally applicable to individual users and/or partnerships subscribing to and/or providing open banking services.

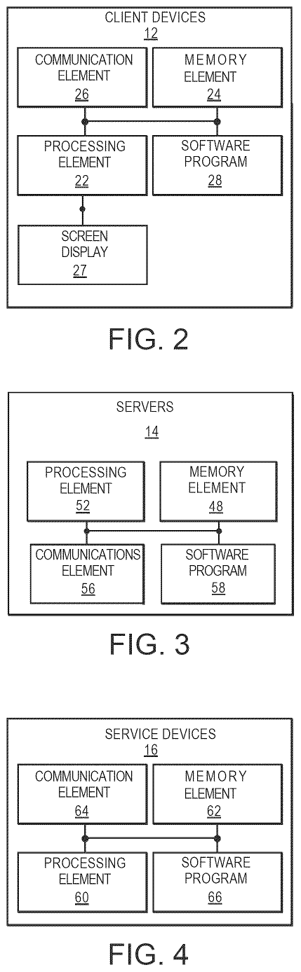

Turning to FIGS. 2 and 4, generally the client devices 12 and the service devices 16 may include tablet computers, laptop computers, desktop computers, workstation computers, smart phones, smart watches, and the like. In one or more embodiments, the client devices 12 and/or the service devices 16 may comprise server(s), examples of which are discussed in more detail below.

Client devices 12 and service device(s) 16 may each respectively include a processing element 22, 60, a memory element 24, 62, and circuitry capable of wired and/or wireless communication with the communication network 20, including, for example, a transceiver or communication element 26, 64. Each of the client devices 12 may additionally include a screen display 27, which may comprise a user interface of the client device 12. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen.

Further, each of the client devices 12 and the service device 16 may include a software application or program 28, 66 configured with instructions for performing and/or enabling performance of at least some of the steps set forth herein. In an embodiment, the software programs 28, 66 each comprises instructions respectively stored on computer-readable media of a memory element 24, 62.

The servers 14 generally receive requests and/or consents for data sharing from the client devices 12—directly or indirectly via the service device 16—and expose or otherwise provide such subject data and other data to the service device 16 for intake, aggregation, analysis and consented sharing managed by the service device 16. In one or more embodiments, a service device 16 enrolls all or some of the client devices 12 and servers 14 and/or the resources embodied thereby for receipt of and/or participation in the open banking services.

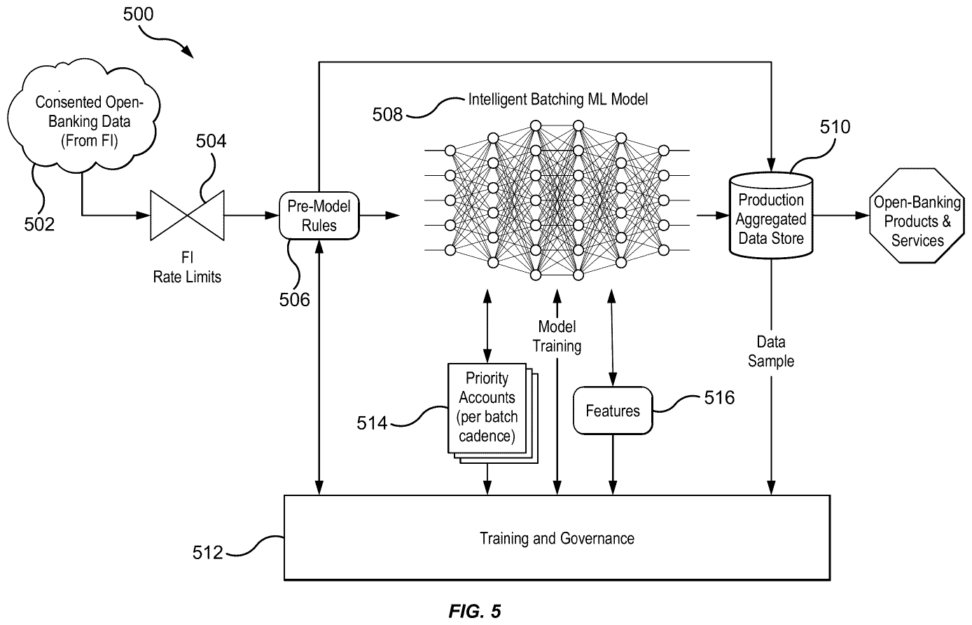

The servers 14 may comprise cloud servers, domain controllers, application servers, database servers, database web servers, file servers, mail servers, catalog servers or the like, or combinations thereof. In one or more embodiments, one or more data sources (e.g., Consented Open Banking FI Data 502 of FIG. 5) may be maintained by one or more of the servers 14. Generally, each server 14 may include a memory element 48, a processing element 52, a communication element 56, and a software program 58.

The communication network 20 generally allows communication between the client devices 12, the servers 14, and the service device 16, for example in conjunction with device enrollment, data acquisition, data consenting, data aggregation, data analysis and data sharing with recipient devices in connection with open banking services provided by the service device 16.

The communication network 20 may include the Internet, cellular communication networks, local area networks, metro area networks, wide area networks, cloud networks, plain old telephone service (POTS) networks, and the like, or combinations thereof. The communication network 20 may be wired, wireless, or combinations thereof and may include components such as modems, gateways, switches, routers, hubs, access points, repeaters, towers, and the like. The client devices 12, servers 14 and/or services device(s) 16 may, for example, connect to the communication network 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 26, 56, 64 generally allow communication between the client devices 12, the servers 14, the service device 16 and/or the communication network 20. The communication elements 26, 56, 64 may include signal or data transmitting and receiving circuits, such as antennas, amplifiers, filters, mixers, oscillators, digital signal processors (DSPs), and the like. The communication elements 26, 56, 64 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 26, 56, 64 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 56, 64 may establish communication through connectors or couplers that receive metal conductor wires or cables, like Cat 6 or coax cable, which are compatible with networking technologies such as ethernet. In certain embodiments, the communication elements 26, 56, 64 may also couple with optical fiber cables. The communication elements 26, 56, 64 may respectively be in communication with the processing elements 22, 52, 60 and/or the memory elements 24, 48, 62.

The memory elements 24, 48, 62 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 48, 62 may be embedded in, or packaged in the same package as, the processing elements 22, 52, 60. The memory elements 24, 48, 62 may include, or may constitute, a “computer-readable medium.” The memory elements 24, 48, 62 may store the instructions, code, code segments, software, firmware, programs, applications, apps, services, daemons, or the like that are executed by the processing elements 22, 52, 60. In an embodiment, the memory elements 24, 48, 62 respectively store the software applications/programs 28, 58, 66. The memory elements 24, 48, 62 may also store settings, data, documents, sound files, photographs, movies, images, databases, and the like.

The processing elements 22, 52, 60 may include electronic hardware components such as processors. The processing elements 22, 52, 60 may include digital processing unit(s). The processing elements 22, 52, 60 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 52, 60 may generally execute, process, or run instructions, code, code segments, software, firmware, programs, applications, apps, processes, services, daemons, or the like. For instance, the processing elements 22, 52, 60 may respectively execute the software applications/programs 28, 58, 66. The processing elements 22, 52, 60 may also include hardware components such as finite-state machines, sequential and combinational logic, and other electronic circuits that can perform the functions necessary for the operation of embodiments of the current invention. The processing elements 22, 52, 60 may be in communication with the other electronic components through serial or parallel links that include universal busses, address busses, data busses, control lines, and the like.

Data queries or requests for services may be initiated via user applications embodied, controlled and/or executed by client devices 12, servers 14 and/or service device(s) 16. In an embodiment, access to user applications, client devices 12, servers 14 and/or service device(s) 16 is granted via one or more authentication framework(s) such as those outlined above, for example where account identification and consents are provided by one or both of the open banking service platform and the platform(s) of financial institution(s) at which data subjects hold accounts.

Data sources hosted by the servers 14 may utilize a variety of formats and structures within the scope of the invention. For instance, relational databases and/or object-oriented databases may embody the data sources and may be exposed for queries by one or more corresponding APIs. One of ordinary skill will appreciate that—while examples presented herein may discuss specific types of operating systems and/or databases—a wide variety may be used alone or in combination within the scope of the present invention.

In one or more embodiments, the software program 58 of one or more of the servers 14 may translate data from the authentication management framework and/or from the client device(s) 12 into identity information for use in connection with authenticating individuals or end users (i.e., data subjects or consented data recipients) for access to data and services by the service device 16 and data recipients. One of ordinary skill will appreciate that a variety of user or data subject information—including, without limitation, credentials and/or biometric or device data—may comprise and/or be used to generate the identity information within the scope of the present invention. It is foreseen that the program 58 may function in connection with a variety of authentication frameworks without departing from the spirit of the present invention.

The program 58 may be configured with policies that define limits to data access, for example with respect to data volume and/or frequency/timing of access events, by the service device 16. In one or more embodiments, these may include financial institution (FI) rate limits (e.g., FI Rate Limits 504 of FIG. 5). The program 58 may permit service device 16 and/or a service provider employee of the open banking service to have limited access to those aspects and data entries/records which are consented by the corresponding data subject (and, optionally, the financial institution(s)), including under the authentication management framework, within the FI rate limits (e.g., as expressed in terabytes per day per open banking service provider, or the like).

One of ordinary skill will appreciate that the software program 28 of one or more of the client devices 12 may similarly manage access by the service device 16 to aspects of the client devices 12 and/or data stored thereby, particularly where such aspects form a part of or relate to the consented data of the data subject. In one or more embodiments, the service device 16 negotiates such limits (e.g., imposed by FIs operating the server(s) 14 and/or by client device 12) by prioritizing data access and aggregation for open banking services which require more frequent access, are in more demand, or otherwise to optimize and balance business objectives of the open banking service provider. Additional detailed discussion regarding such limits is included below.

In one or more embodiments, the service device 16 implements an open banking service for client devices 12 controlled by data recipient subscribers. The data recipient subscribers, for example, may calculate credit scores, open new financial accounts, provide advice about improving credit scores, approve loan requests and otherwise perform financial-related tasks for data subjects.

In one or more embodiments, performance of the open banking services includes the service device 16 processing queries from one or more of the devices 12, 14 about, to support and/or as a part of the open banking services. Data recipient and subject subscribers (or open banking service customers) may: rate the quality of the services; rate the quality of the data and calculated scores or the like; rate the responsiveness and/or latency of the open banking services platform; change update, batching and aggregation requirements under agreement with the open banking services platform provider; or otherwise provide feedback or input to the open banking services platform provider which may, as discussed in more detail below, be used to automatically modify algorithm(s) and model(s) for skip and batch decisioning of FI data.

Embodiments of the present invention include a machine learning (ML) model for dynamically and automatically making skip and batch decisioning for FI data on an account-by-account basis according to multivariate factors, for example based on customer feedback, FI rate limit(s), cost and efficiency concerns and the like.

For example, open banking data intake, aggregation and analysis may be improved by training, retraining and modifying the ML model and associated pre-model rules to balance multivariate open banking service objectives and data source (i.e., FI) restrictions and limitations (e.g., data volume and frequency or rate limits discussed above) to optimize the open banking services.

In one or more embodiments, the program 66 is configured to automatically improve skip and batch decisioning relative to system objectives (such as those discussed in more detail above) through a training and governance algorithm. In one or more embodiments, the training and governance algorithm maintains objective functions representing the system objectives or goals, including customer feedback, FI rate limit(s), and cost and efficiency concerns. The training and governance algorithm may comprise or include a genetic algorithm implementing selection pressures through the objective functions and modifications thereto within the scope of the present invention. The training and governance algorithm of the program 66 may iteratively modify pre-model rules and the ML model to obtain better outputs from the objective functions.

Based on a difference between the performance data for the pre-model rules and the ML model for skip and batch decisioning on the one hand, and the system objectives on the other hand, the training and governance algorithm may automatically identify modifications comprising at least one of the following: a modification to the pre-model rules; a training action for the ML model; and a feature modification to the ML model. One or more of the modifications may be implemented to generate at least one of modified pre-model rules and a modified or retrained ML model for use in future skip and batch decisioning. A modified ML model may include changes to ML model features such as an input vector and/or embeddings (e.g., variable input type(s) and/or weightings or the like), and/or may include changes to the composition of the model itself (e.g., weightings and/or connections at hidden layers in the case of a deep neural network or the like).

The modification(s) may be identified based at least in part on previous learning and/or correlations. Where the training and governance algorithm comprises a genetic algorithm, one of ordinary skill will appreciate that a degree of informed randomness may guide such changes and yield such learning and correlations over time. For example, where the program 66 previously encountered a difference (between ML model performance and the system objectives) of the type and/or extent observed in the present iteration, and successfully produced movement toward a system objective by implementing a particular change or modification to the pre-model rules and/or ML model, the program 66 may be configured to automatically identify and select same or an analogous modification for implementation.

In turn, the program 66 may be configured to automatically gather and generate training data, as needed, and to otherwise implement the identified modification to the pre-model rules and/or ML model. The program 66 may further be configured to execute the identified modification to retrain the ML model and/or modify its features and/or input vector(s), and/or to modify the pre-model rules. For example, the program 66 may be configured to perform statistical regression on account data parameters relating to ML model features (e.g., time since last batch, account activity levels, average account balance, customer data requirements, etc.) and the decisioning output by the ML model to identify ranges for values of the account data parameters which almost always or always lead to a given ML model decision (i.e., skip or batch). Wherever such relationships or correlations are identified with a threshold degree of certainty and/or across a minimum sample size, the training and governance algorithm of the program 66 may automatically generate pre-model rules and/or modifications to the pre-model rules to embody the observed correlations and move such decisioning from the ML model to the pre-model rules, thereby improving efficiency and reducing computational burden in the decisioning process. Correspondingly, the program 66 may determine that better accuracy may be attained by the ML model by modifying the features and/or input vectors thereof, and/or conducting retraining, to account for the aforementioned shift of responsibility to the pre-model rules for such accounts, and may implement same.

For another example, the program 66 may be configured to include and implement an objective function representative of customer satisfaction (relative to open banking services) to include consideration of and/or greater weighting for high priority customer satisfaction (e.g., customers who have requested more responsive service levels). Wherever the ML model and/or pre-model rules are configured to decision for FI accounts corresponding to various levels of such customer prioritization, present decisioning may be determined to be insufficient with respect to prioritizing accuracy, timeliness or other aspects of performance for high priority customer accounts. The objective function of the program 66 (e.g., the training and governance algorithm thereof) representative of customer satisfaction may monitor customer feedback and/or customer satisfaction performance metrics accessible to the program 66 (e.g., time to response, incidence rates of incomplete or low quality records, etc.), and may determine that such performance for high priority customer accounts is insufficient. Accordingly, the program 66 may: update the priority accounts lookup table; modify the pre-model rules to increase the focus on satisfying high priority customers; modify the features and/or input vector(s) of the ML model to increase focus on satisfying high priority customers; and/or retrain the ML model to increase focus on satisfying high priority customers.

One of ordinary skill will appreciate that a variety of observations may be made by a training and governance algorithm, based on a variety of monitored performance and feedback data, and that a variety of modifications and adjustments may be made accordingly, without departing from the scope of the present invention.

An example system 500 for implementing embodiments of the present invention is illustrated in FIG. 5. The system 500 includes: an FI datasource 502, such as a server 14 and/or API, providing open-banking data consented for the uses described herein; an FI rate limit controller 504; pre-model rules 506; an intelligent batching ML model 508; a production aggregation data store or database 510; a training and governance algorithm 512; a priority accounts lookup table 514; and a features modifier 516. The components 506, 508, 510, 512, 514 and 516 may be hosted and/or managed at the direction of an open banking services platform device (e.g., a service device 16 and/or server(s) 14). The production aggregated data store 510 may supply data to and/or be accessed by open banking services platform devices for provision of open banking services to customers. It should also be noted that the FI rate limit controller 504 may be hosted and/or managed at the direction of an open banking services platform device or by an FI server (e.g., a server 14) within the scope of the present invention, and may restrict access to FI data that exceeds corresponding rate limits.

One of ordinary skill will appreciate that responsibility for all or some of such components may be distributed differently among such devices or other computing devices without departing from the spirit of the present invention.

FI datasource 502 and any sources of training data for the ML model 508 may respectively obtain the data from data subjects, FIs or service providers, or other sources. The data stored at the aggregated data store 510, input to and/or used to retrain the ML model, input to the pre-model rules 506, and/or input to the training and governance algorithm 512, may comprise open banking data, FI data regarding data subjects (accounts) and/or FI terms and rate limits, account records, transaction and credit card data, firmographic entity data, location data, value data, regulatory data, personally identifiable information (PII), entity identification and/or authentication data, and/or other financial and relevant data. The data monitored by, retrieved by, and/or input to the training and governance algorithm 512 may include metadata describing system performance (e.g., computation times, response times, customer satisfaction feedback, computational load, engineering burden and/or expenditures, quality of data in the data store 510, and other data originating in the system 500 and/or received from customers and related to evaluation of objective functions and/or generation of modifications to the pre-model rules 506 and/or ML model 508). It should also be noted that input data sources may comprise textual data, audio recordings and/or data and/or image data (e.g., images, videos, emojis, unstructured text, labeled/structured text, and the like) within the scope of the present invention.

Pre-model rules 506 may comprise logic and/or algorithms for preemptively assigning accounts for exclusion from or inclusion in an upcoming aggregation batch. Input to the pre-model rules may include account data for each account of a plurality of FI accounts under consideration for inclusion in the upcoming aggregation batch. The account data may include the same or similar data for each of the accounts which is input to the ML model 508, described in more detail below. For example, the account data may include FI data rate limit, account stagnation, average balance of FI account, time since last batch, cost of data storage for the account, data storage engineering burden for the account, permission/consent adherence for the account, and and/or high value FI account lists. One of ordinary skill will appreciate that a variety of data may be relevant and input to the pre-model rules 506 for preemptive inclusion or exclusion of accounts within the scope of the present invention. Moreover, it should be appreciated that the pre-model rules may be configured as various algorithms - such as, for example, weighted summations of a plurality of variables, decision trees, or the like - within the scope of the present invention.

The pre-model rules 506 may be dynamically adjusted to improve system performance (e.g., by alleviating computational burden on the ML model 508, as discussed in more detail above) according to system objectives. In one or more embodiments, the pre-model rules route FI accounts for data updates wherever confidence in such routing is sufficiently high to warrant treatment under such a preclusive rule rather than under the more computationally intensive ML model 508.

The ML model 508 provides decisioning computations for FI accounts of those under consideration which are not preemptively routed according to the pre-model rules 506. As discussed elsewhere herein, the ML model 508 is trained and retrained, and its features may be iteratively modified, to maximize skip and batch decisioning performance according to a variety of metrics. For example, performance may be determined, and modifications identified, based on one or more of: a data sample of the aggregated data store (from which, e.g., data quality or fitness for an open banking service may be determined); an open banking service performance metric (e.g., relatively indirect measures of quality for open banking services relying on the aggregated data store 510 contents); open banking feedback data from one or more customers (e.g., speaking to one or more of the performance metrics, changing account priority levels, or otherwise addressing topics related to system objectives); and an internal open banking data aggregation metric (e.g., response time, computation time, resource consumption, accuracy relative to service level requirements, and other metrics). The ML model 508 may comprise a deep neural network (DNN) with a boosting algorithm. However, a variety of machine learning models may be included in and/or comprise the ML model 508 without departing from the spirit of the present invention.

Moreover, the ML model 508 may include features and/or may receive input vectors populated or calculated based on one or more of the following data types: FI data rate limit, account stagnation (and/or frequency of account activity), average balance of FI account, time since last batch of the account, cost of data storage, data storage engineering burden, uptime, permission/consent adherence, and high value FI account definition. One of ordinary skill will appreciate that a variety of data types may be embodied in features and/or input vectors for a machine learning skip and batch decisioning model for improving performance according to system objectives without departing from the spirit of the present invention.

A preliminary step according to embodiments of the present invention may include selecting a ML model 508 trained on data corresponding to system objectives and/or the open banking service and/or region in which the open banking service will predominantly be provided. For example, the ML model may be trained on English, French, Spanish, German, Mandarin, Cantonese, Arabic, Hindi or other languages, and may be more particularly trained on data filtered for region or ethnicity (e.g., American English or British English), financial channel and/or other differences. Because the ML model will mostly encounter and output data unique to open banking, it is also foreseen that additional filters—such as for data or language used in economic, financial and transactional contexts—may additionally be applied to select a ML model trained on particularly relevant data within the scope of the present invention.

Further, training or retraining of an ML model may be initially performed (e.g., before being placed in a production environment for data aggregation supporting open banking services) in view of the open banking service and system objective(s) for which it is to be used. In one or more embodiments, such initial training includes one or more of self-supervised, supervised and/or reinforcement learning. As discussed in more detail above, the initial training may be performed with data types including open banking data such as memo or description fields of open banking records, FI data regarding data subjects and/or FI terms and rate limits, transaction and credit card data, account data, firmographic entity data, location data, value data, regulatory data, PII, entity identification and/or authentication data, and/or other financial and relevant data, and combinations thereof.

Similarly, the initially trained ML model 508 may be tested with one or more sets of pre-model rules 506, and may be retrained in view of such initial testing, to determine initial performance in terms of capabilities, efficiency, cost and accuracy with reference to the open banking service and system objective(s) for which it is to be used.

As discussed in more detail below, iterative modifications to the pre-model rules 506 and/or ML model 508 are also undertaken in or following use in a production environment, based on differences between production environment outputs/performance/assessments and system objectives, to dynamically and automatically provide open banking services and move the data aggregation decisioning toward the system objectives.

The modifications determined and/or identified by the training and governance algorithm 512 are preferably defined for a variety of system objectives and/or metrics relating thereto, a variety of differences between outputs/performance and those objectives, and combinations thereof, and prescribe different types of training, feature modifications, priority account lookup table modifications, pre-model rule modifications and the like.

Moreover, such system modifications may be generated, defined, identified and/or selected by the training and governance algorithm 512 based on performance metrics and/or customer feedback over multiple batches and/or longer periods of time (in contrast with or addition to implementation in response to each batch aggregation individually). The training and governance algorithm 512 may analyze performance and feedback data for aggregation decisioning by the ML model 508 over the period using the objective functions. The training and governance algorithm 512 may, based on the analysis, determine patterns for how well the ML model 508 performed across multiple metrics or characteristics relating to the system objective(s), and may use the patterns to identify appropriate modifications—including by applying corresponding selection pressures for system evolution where embodied in a genetic algorithm to refine such modifications—for improving future performance.

For example, modifications identified and implemented by the training and governance platform 512 may include one or more of: modifications to the pre-model rules 506; updates to the priority account lookup table 514; retraining the ML model 508; and/or modifying the features of the ML model 508 via features modifier 516. The training and governance platform 512 may subsequently iterate its monitoring and information gathering to assess the performance of the modified components of the system 500 against the objective functions and perform future iterations accordingly.

Objective functions and/or system objectives may embody one or more of the following: account deduplication, reduced data storage costs, reduced data processing costs, increased open banking service quality metrics, aggregation maximization relative to an FI rate limit, and data quality in the aggregated data store. It should also be noted that system objective(s) may be modified or updated according to customer feedback and/or input from open banking service platform personnel (e.g., adjusting the relative importance of system objectives and/or the composition of the objective function(s)).

As noted above, the training and governance algorithm may comprise non-linear, recursive, and super literal genetic algorithms. One of ordinary skill will appreciate, however, that other decisioning and objective function evaluation algorithms and techniques are within the scope of the present invention.

Through hardware, software, firmware, or various combinations thereof, the processing elements 22, 52, 60 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled, unless otherwise expressly stated and/or readily apparent to those skilled in the art from the description.

### Exemplary Computer-Implemented Method for Providing Dynamic Open Banking Data Aggregation

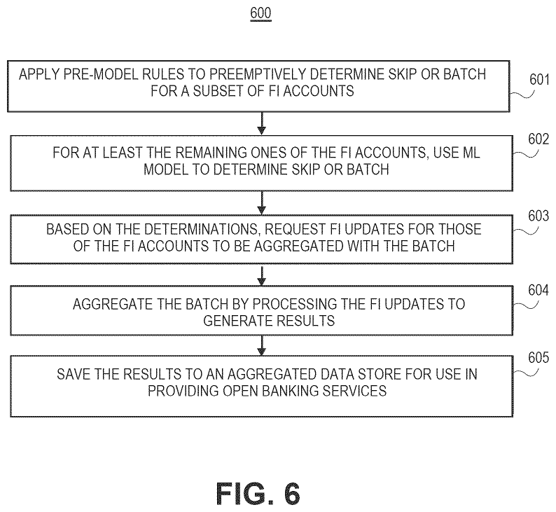

FIG. 6 depicts a flowchart including a listing of steps of another exemplary computer-implemented method 600 for providing dynamic open banking data aggregation decisioning. The steps may be performed in the order shown in FIG. 6, or they may be performed in a different order. Furthermore, some steps may be performed concurrently as opposed to sequentially. In addition, some steps may be optional.

The computer-implemented method 600 is described below, for ease of reference, as being executed by exemplary devices and components introduced with the embodiments illustrated in FIGS. 1-5. For example, the steps of the computer-implemented method 600 may be performed by the client devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 601, pre-model rules may be applied to preemptively determine whether one or more FI accounts should be skipped or batched as part of an upcoming aggregation batch. In one or more embodiments, the pre-model rules may be pre-model rules 506 discussed in more detail above and/or are applied by a software program of an open banking service platform (e.g., program 66 of service device 16).

It should be noted that FI accounts under consideration for inclusion in the upcoming aggregation batch may comprise all accounts at an individual FI, all accounts at FIs having a common rate limit, or other groupings of FI accounts, without departing from the spirit of the present invention. It should also be appreciated that one or more filters may be applied to reduce the total FI accounts to only those under consideration for the upcoming batch, for example where a filter for recently-batched accounts or another criterion is applied to remove accounts from the group under consideration.

The pre-model rules may be applied to input account data and as described in more detail above.

FI accounts meeting the criteria or otherwise satisfying one or more of the pre-model rules may accordingly be preemptively included in the upcoming aggregation batch and data update processes, and/or preemptively excluded therefrom, dependent on the configuration of the particular pre-model rule applied. For example, a first subset of the FI accounts meeting one or more inclusion rules may be designated for inclusion in the aggregation batch.

Referring to step 602, account data, for at least those of the FI accounts under consideration for inclusion in the upcoming aggregation batch which were not preemptively routed by the pre-model rules, may be submitted to a machine learning (ML) model for skip or batch decisioning. In one or more embodiments, the ML model performs the decisioning as discussed in more detail above, receives the account data as input to and/or generates skip or batch decisioning outputs for the remaining ones of the FI accounts at or as part of a software program of an open banking service platform device (e.g., program 66 of service device 16), and/or is hosted at and/or controlled by such a device.

The ML model may receive input account data, including as part of or in relation to model features and/or as an input vector, as described in more detail above. In one or more embodiments, the ML model comprises a deep neural network (DNN) with a boosting algorithm. However, a variety of machine learning models may be included in and/or comprise the ML model without departing from the spirit of the present invention.

FI accounts may accordingly be designated by the ML model for inclusion in the upcoming aggregation batch and data update processes, and/or for exclusion therefrom. For example, account data for a second subset of the FI accounts may be input to the ML model, and the ML model may output designations of a third subset of the FI accounts to be included in the aggregation batch and/or of a fourth subset of the FI accounts not to be included in the aggregation batch.

Referring to step 603, based on the determinations from the pre-model rules and the ML model, data updates may be requested for those of the FI accounts designated for inclusion in the aggregation batch. In one or more embodiments, the data updates may be requested as discussed in more detail above and/or may be made and/or managed by a software program of an open banking service platform (e.g., program 66 of service device 16).

The data updates for the FI accounts included in the aggregation batch may be requested from one or more devices under the control of the corresponding FI and in accordance with applicable rate limit(s) thereof, as described in more detail above. In the example discussed above, data updates for the first and third subsets may be requested.

Referring to step 604, the received data updates for the FI accounts included in the aggregation batch may be processed or aggregated to generate results. In one or more embodiments, the aggregation may be performed as discussed in more detail above and/or by a software program of an open banking service platform (e.g., program 66 of service device 16).

The results of the aggregation may be data values, logical outputs, or other results necessary for bringing profiles or representations of the FI accounts of the batch up to date, as of the time of aggregation. For example, the results may, for each of the FI accounts batched, include an updated account balance, a list of recent transactions, an updated data recipient financial score, and/or other datapoints stored in an aggregated data store for reliance on in performance of open banking services.

Referring to step 605, the results of the aggregation or data update processing are saved to the open banking aggregated data store. In one or more embodiments, the data store is a database hosted by the open banking service platform and/or managed by a software program of an open banking service platform (e.g., program 66 of service device 16).

In one or more embodiments, the data store is periodically or continuously available for use by device(s) of the open banking service platform in providing the open banking services, in each case in accordance with applicable consent restrictions of the data subject and/or source FI. Periodically, the records or entries for one or more of the FI accounts represented in the data store may be sampled for data quality and other analyses, including those discussed in more detail below.

The method may include additional, less, or alternate steps and/or device(s), including those discussed elsewhere herein, unless otherwise expressly stated and/or readily apparent to those skilled in the art from the description.

For example, in one or more embodiments, performance data for the ML model's skip and batch decisioning pursuant to the method 600 may be input to a training and governance algorithm to determine modifications comprising at least one of the following: a modification to the pre-model rules; a training action for the ML model; and a feature modification to the ML model. The one or more modifications may be implemented to generate at least one of modified pre-model rules and a modified ML model.

The training and governance algorithm may comprise one or both of a genetic algorithm and a genetic ML model. In one or more embodiments, the training and governance algorithm is hosted by the open banking service platform and/or managed by or comprises a software program of an open banking service platform (e.g., program 66 of service device 16).

The performance data for the ML model may include: a data sample of the aggregated data store; an open banking service performance metric (e.g., describing how efficiently, quickly and thoroughly open banking service(s) are provided during the relevant period); open banking feedback data from one or more customers (e.g., ratings and/or unstructured text feedback from customer(s)); and an internal open banking data aggregation metric (e.g., time to response, costs to compute and store, and other data available regarding performance of the system).

The training and governance algorithm may, based on analysis of the performance data for the ML model (and pre-model rules), determine one or more modifications to make to the system (e.g., the pre-model rules and/or ML model). In one or more embodiments, the analysis of the performance data and determination of modifications are done in view of one or more objective functions of the training and governance algorithm. The objective functions may embody and/or seek to optimize (alone or in combination, including weighted combinations) one or more of the following objectives: account deduplication, reduced data storage costs, reduced data processing costs, increased open banking service quality metrics, aggregation maximization relative to an FI rate limit, and data quality in the aggregated data store. Moreover, the objective functions and/or training and governance algorithm may be configured to apply selection pressures, owing to a genetic algorithm implementation, via the modifications to advance or evolve the pre-model rules and ML model toward the system objectives.

The modifications determined by the training and governance algorithm may include one or more of the following: a modification to the pre-model rules; a training action for the ML model; and a feature modification to the ML model. One or more of the modifications may be implemented, whether or not simultaneously, to modify the system and move it closer to better performance according to the objective function(s). The training and governance algorithm may operate as described in preceding portions of the disclosure and as described here.

For example, the training and governance algorithm may determine that an account type and/or specific FI account may be receiving unfavorable customer feedback, may be subject to a revised service level requirement, and/or may be underserviced according to a system performance metric. Accordingly, the training and governance algorithm may determine that a training action for the ML model and/or a modification to the pre-model rules should be implemented to prioritize the account type and/or specific FI account.

In one or more embodiments, a training action may comprise a training record definition. The training record definition may be automatically generated by the training and governance algorithm based on observed patterns and correlations between previous training actions and/or aspects of the ML model and its performance with respect to the objective function(s) and/or system objective(s).

The training record definition includes a description of one or more types or categories of data such as open banking records and enables automated curation of a training data set. More particularly, the definition may describe one or more record types, such as open banking data, FI data regarding data subjects and/or FI terms and rate limits, account records, transaction and credit card data, firmographic entity data, location data, value data, regulatory data, personally identifiable information (PII), entity identification and/or authentication data, and/or other financial and related data. The definition may, for each identified data record type, specify whether the data should be labeled, unlabeled, or the like, in each case in accordance with the training to be undertaken (e.g., self-supervised, supervised and/or reinforcement learning), which may also be specified in the definition. The definition may include timestamp or record date ranges and/or limitations, other filters or limitations on records to be used for training, retraining scheduling, model production and replacement schedules, and other details for data preparation for and implementation of the training action.

The training record definition may cause the training and governance algorithm to automatically construct and transmit calls to APIs—for example, of one or more data sources, whether internal at the open banking service provider and/or external at one or more consented FIs—to collect in real-time training data fitting the parameters described in the training record definition. The training and governance algorithm may accordingly automatically curate and/or retrieve training data set(s) and implement/conduct ML model training.

Further, an example of a modification to the pre-model rules may be to require more frequent batching of an FI account of the plurality of FI accounts responsive to a change in customer requirements for open banking services and/or service levels, as discussed in more detail above. It should be reiterated that the account priority may be listed in a lookup table accessible to the pre-model rules and/or ML model. The training and governance algorithm may be configured to update the lookup table responsive to changes in customer requirements for open banking services, with the FI accounts listed as being high priority in the lookup table being fed as input for the computations of the pre-model rules and the ML model.

The modification may also or alternatively include a modification to the ML model (other than or in addition to training), such as where the ML model includes features at least in part embodied by an input vector, and the modification includes modifying the input vector with respect to one or more of the following: FI data rate limit, account stagnation, average balance of FI account, time since last batch, cost of data storage, data storage engineering burden, uptime, permission/consent adherence, and high value FI account definition.

It should be reiterated that a central goal of embodiments of the present invention is to provide a technological mechanism for improved system performance of open banking services. Namely, embodiments of the present invention automatically take steps to shore up perceived weakness(es) in system performance.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. Non-transitory computer-readable storage media having computer-executable instructions stored thereon for providing dynamic open banking data aggregation, wherein when executed by at least one processor the computer-executable instructions cause the at least one processor to:
apply a plurality of pre-model rules to data regarding a plurality of financial institution (FI) accounts to determine that a first subset of the plurality of FI accounts will be included in an aggregation batch;
input the data regarding a second subset of the plurality of FI accounts to a machine learning (ML) model to determine that a third subset of the plurality of FI accounts will be included in the aggregation batch and that a fourth subset of the plurality of FI accounts will not be included in the aggregation batch;
based on the determination from the application of the plurality of pre-model rules and on the determination from the ML model, respectively, request data updates for the first and third subsets from the FI;
batch the aggregation batch by processing the data updates for the first and third subsets to produce results; and
store the results to an aggregated data store.

2. The non-transitory computer-readable storage media of claim 1, wherein, when executed by the at least one processor the computer-executable instructions cause the at least one processor to:
input ML model performance data to a training and governance algorithm to determine one or more modifications comprising at least one of the following: a modification to the pre-model rules; a training action for the ML model; and a feature modification to the ML model,
implement the one or more modifications to generate at least one of the following:
modified pre-model rules; and a modified ML model.

3. The non-transitory computer-readable storage media of claim 2, wherein at least one of the two (2) following sequences occurs—
the training action is determined and implemented and includes retraining the ML model to prioritize an account type,
the modification to the pre-model rules is determined and implemented and includes modifying the pre-model rules to prioritize an account type.

4. The non-transitory computer-readable storage media of claim 2, wherein—
the training and governance algorithm includes one or both of a genetic algorithm and a genetic ML model,
the one or more modifications are configured to apply one or more selection pressures based on analysis of the ML model performance data and corresponding modification of one or more objective functions of the training and governance algorithm.

5. The non-transitory computer-readable storage media of claim 4, wherein the one or more objective functions embody one or more of the following objectives: account deduplication, reduced data storage costs, reduced data processing costs, increased open banking service quality metrics, aggregation maximization relative to an FI rate limit, and data quality in the aggregated data store.

6. The non-transitory computer-readable storage media of claim 2, wherein the ML model performance data includes one or more of the following: a data sample of the aggregated data store; an open banking service performance metric; open banking feedback data from one or more customers; and an internal open banking data aggregation metric.

7. The non-transitory computer-readable storage media of claim 2, wherein the feature modification is determined and is implemented at least in part by modifying an input vector for the ML model with respect to one or more of the following: FI data rate limit, account stagnation, average balance of FI account, time since last batch, cost of data storage, data storage engineering burden, uptime, permission/consent adherence, and high value FI account definition.

8. The non-transitory computer-readable storage media of claim 2, wherein the modification to the pre-model rules is determined and implemented and includes modifying the pre-model rules to require more frequent batching of an FI account of the plurality of FI accounts responsive to a change in customer requirements for open banking services.

9. The non-transitory computer-readable storage media of claim 8, wherein the FI account is listed with a fifth subset of priority ones of the plurality of FI accounts in a lookup table, the training and governance algorithm being configured to update the lookup table responsive to changes in customer requirements for open banking services and the fifth subset of the lookup table being input for the pre-model rules and the ML model.

10. The non-transitory computer-readable storage media of claim 1, wherein the ML model comprises a deep neural network with a boosting algorithm.

11. A computer-implemented method for providing dynamic open banking data aggregation, comprising, via one or more transceivers and/or processors:
applying a plurality of pre-model rules to data regarding a plurality of financial institution (FI) accounts to determine that a first subset of the plurality of FI accounts will be included in an aggregation batch;
inputting the data regarding a second subset of the plurality of FI accounts to a machine learning (ML) model to determine that a third subset of the plurality of FI accounts will be included in the aggregation batch and that a fourth subset of the plurality of FI accounts will not be included in the aggregation batch;
based on the determination from the application of the plurality of pre-model rules and on the determination from the ML model, respectively, requesting data updates for the first and third subsets from the FI;
batching the aggregation batch by processing the data updates for the first and third subsets to produce results; and
storing the results to an aggregated data store.

12. The computer-implemented method of claim 11, comprising:
inputting ML model performance data to a training and governance algorithm to determine one or more modifications comprising at least one of the following: a modification to the pre-model rules; a training action for the ML model; and a feature modification to the ML model,
implementing the one or more modifications to generate at least one of the following:
modified pre-model rules; and a modified ML model.

13. The computer-implemented method of claim 12, wherein at least one of the two (2) following sequences occurs—
the training action is determined and implemented and includes retraining the ML model to prioritize an account type,
the modification to the pre-model rules is determined and implemented and includes modifying the pre-model rules to prioritize an account type.

14. The computer-implemented method of claim 12, wherein—
the training and governance algorithm includes one or both of a genetic algorithm and a genetic ML model,
the one or more modifications are configured to apply one or more selection pressures based on analysis of the ML model performance data and corresponding modification of one or more objective functions of the training and governance algorithm.

15. The computer-implemented method of claim 14, wherein the one or more objective functions embody one or more of the following objectives: account deduplication, reduced data storage costs, reduced data processing costs, increased open banking service quality metrics, aggregation maximization relative to an FI rate limit, and data quality in the aggregated data store.

16. The computer-implemented method of claim 12, wherein the ML model performance data includes one or more of the following: a data sample of the aggregated data store; an open banking service performance metric; open banking feedback data from one or more customers; and an internal open banking data aggregation metric.

17. The computer-implemented method of claim 12, wherein the feature modification is determined and is implemented at least in part by modifying an input vector for the ML model with respect to one or more of the following: FI data rate limit, account stagnation, average balance of FI account, time since last batch, cost of data storage, data storage engineering burden, uptime, permission/consent adherence, and high value FI account definition.

18. The computer-implemented method of claim 12, wherein the modification to the pre-model rules is determined and implemented and includes modifying the pre-model rules to require more frequent batching of an FI account of the plurality of FI accounts responsive to a change in customer requirements for open banking services.

19. The computer-implemented method of claim 18, wherein the FI account is listed with a fifth subset of priority ones of the plurality of FI accounts in a lookup table, the training and governance algorithm being configured to update the lookup table responsive to changes in customer requirements for open banking services and the fifth subset of the lookup table being input for the pre-model rules and the ML model.

20. The computer-implemented method of claim 11, wherein the ML model comprises a deep neural network with a boosting algorithm.
